(19) United States
(12) Patent Application Publication
(10) Pub. No.: US 2018/0152888 A1
(43) Pub. Date: May 31, 2018

(54) BASE STATION AND CROSS-LAYER METHOD FOR SLEEP SCHEDULING THEREOF

(71) Applicant: INSTITUTE FOR INFORMATION INDUSTRY, Taipei City (TW)

(72) Inventors: Jen-Jee Chen, Tainan City (TW); Shuang-Cheng Yang, Changhua County (TW); Jia-Ming Liang, Taoyuan City (TW); KUN-RU WU, Kaohsiung City (TW); Yu-Chee Tseng, Hsinchu City (TW); Chih-fu Yang, Taipei City (TW)

(21) Appl. No.: 15/377,581

(22) Filed: Dec. 13, 2016

(30) Foreign Application Priority Data
Nov. 28, 2016 (TW) 105139078

(51) Int. Cl. H04W 52/02; H04W 72/04; H04L 1/00

(52) U.S. Cl. CPC H04W 52/0219; H04W 52/0251; H04L 1/0002; H04W 72/0446

(57) ABSTRACT

A cross-layer method for sleep scheduling is executed by a base station serving to at least one mobile device, and the method comprises the steps of: searching for a plurality of environment parameters of the base station and the at least one mobile device; dynamically allocating at least one subframe to a first scheduling block of the at least one mobile device for achieving an initial schedule according to the plurality of environment parameters; and dynamically adjusting the first scheduling block of the at least one mobile device in the at least one subframe and at least one modulation and coding scheme corresponding to the first scheduling block for achieving a real-time schedule according to the plurality of environment parameters and the initial schedule.

### BACKGROUND

### 1. Technical Field

The present disclosure relates to a cross-layer method for sleep scheduling, in particular, to a base station and a cross-layer method for sleep scheduling executed by the base station.

### 2. Description of Related Art

How to effectively prolong the battery life for smart mobile devices has become a critical problem because of the popularity of smart mobile devices. In terms of conventional wireless communication interfaces using the 4^{th} (even the upcoming 5^{th}) generation mobile networks, the power consumption rate increases inevitably. Thus, it is an urgent issue to provide a method for sleep scheduling to optimize the power-saving mechanism of conventional wireless communication interfaces.

### SUMMARY

The primary purpose of the present disclosure is to provide a base station and a cross-layer method for sleep scheduling thereof applicable to the media access control (MAC) layer and physical (PHY) layer. The present disclosure considers the MAC layer which optimizes the parameters such as the sleep period, on duration, offset, inactivity timer, and so on to save power by using Discontinuous Reception/Transmission (DRC/DTX), as well as setting of the MAC layer and PHY layer and allocating transmission power, resources in physical blocks, modulation and coding scheme, data transmission quantity, and so on of a plurality of mobile devices in each subframe. For the sake of optimizing the power efficiency of mobile devices and promoting the quality of service for data streams, the present disclosure further provides the function of delay constraint to mobile devices to effectively save power. When a mobile device is in a poor transmission channel quality, the present disclosure enables the mobile device not to transmit data until the transmission channel quality becomes better, for example, when the next subframe comes, so as to ensure the quality of service of the mobile device not to be affected.

According to one exemplary embodiment of the present disclosure, a cross-layer method for sleep scheduling is provided and executed by a base station serving to at least one mobile device. The method comprises the steps: searching for a plurality of environment parameters of the base station and the at least one mobile device; dynamically allocating at least one subframe to a first scheduling block of the at least one mobile device for achieving an initial schedule according to the plurality of environment parameters; and dynamically adjusting the first scheduling block of the at least one mobile device in the at least one subframe and at least one modulation and coding scheme corresponding to the first scheduling block for achieving a real-time schedule according to the plurality of environment parameters and the initial schedule.

According to the other exemplary embodiment of the present disclosure, a base station adapted to serve to at least one mobile device and execute a cross-layer method for sleep scheduling comprises the steps: searching for a plurality of environment parameters of the base station and the at least one mobile device; dynamically allocating at least one subframe to a first scheduling block of the at least one mobile device for achieving an initial schedule according to the plurality of environment parameters; and dynamically adjusting the first scheduling block of the at least one mobile device in the at least one subframe and at least one modulation and coding scheme corresponding to the first scheduling block for achieving a real-time schedule according to the plurality of environment parameters and the initial schedule.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 is a flowchart of an embodiment of the cross-layer method for sleep scheduling of the present disclosure.

FIG. 2 is a schematic diagram of an embodiment of the base station of the present disclosure serving to at least one mobile device.

FIG. 3 is a schematic diagram of an embodiment of one initial schedule of the present disclosure.

FIG. 4 is a flowchart of an embodiment of one initial schedule of the present disclosure.

FIG. 5 is a schematic diagram of an embodiment of the present disclosure before another initial schedule is made.

FIG. 6 is a flowchart of an embodiment of another initial schedule of the present disclosure.

FIG. 7 is a schematic diagram of an embodiment of the present disclosure after another initial schedule is made.

FIG. 8 is a flowchart of an embodiment of the subframe of the present disclosure allocating scheduling blocks.

FIG. 9 is a flowchart of an embodiment of the real-time schedule of the present disclosure.

FIG. 10 is a schematic diagram of an embodiment of the scheduling block and residual power of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

It will be understood that, although the terms first, second, third, and the like, may be used herein to describe various elements, these elements should not be limited by these terms. These terms are only to distinguish one element or signal from another. For example, a first element or signal could be termed a second element or signal and, similarly, a second element or signal could be termed a first element or signal without departing from the teachings of the instant disclosure. As used herein, the term “and/or” includes any and all combinations of one or more of the associated listed items.

The Long-term evolution/Long-term evolution-advanced (LTE/LTE-A) communication systems provides sleep mode to wireless access networks and mobile devices, enabling mobile devices to enter sleep mode when there are no data to transmit so as to save power as well as to prolong the battery life. The present disclosure provides a base station and a cross-layer method for sleep scheduling thereof applicable to the media access control (MAC) layer and physical (PHY) layer. The present disclosure considers the MAC layer which optimizes the parameters such as the sleep period, on duration, offset, inactivity timer, and so on to save power by means of Discontinuous Reception/Transmission (DRX/DTX), as well as setting of the MAC layer and PHY layer and allocating transmission power, resources in physical blocks, modulation and coding scheme, data transmission quantity, and so on of a plurality of mobile devices in each subframe.

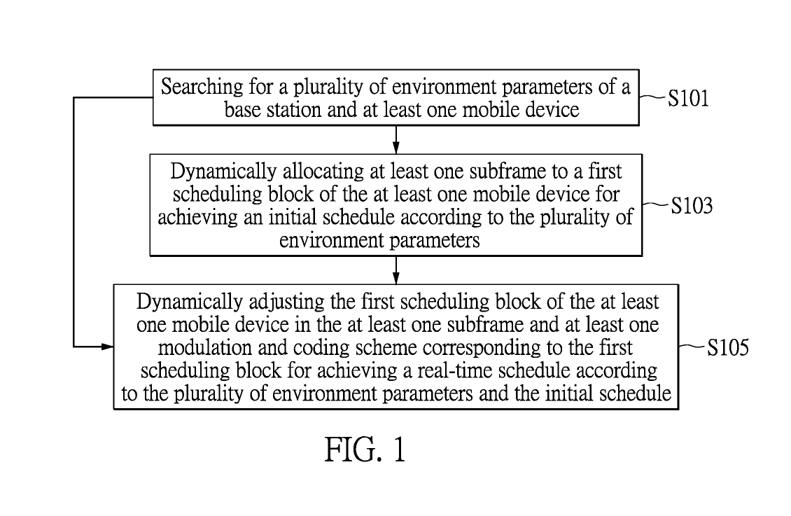

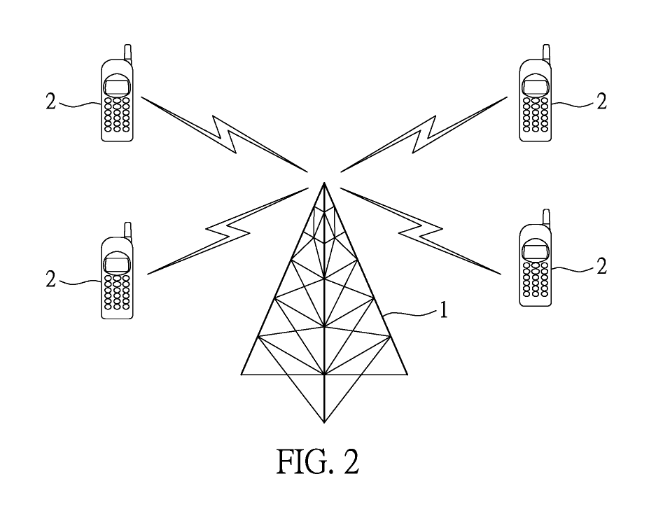

As shown in FIG. 1 and FIG. 2, a cross-layer method for sleep scheduling of the present embodiment is executed by a base station 1 (Evolved node B, eNB) which serves to at least one mobile device 2 (user equipment, UE), wherein the base station 1 includes logic, circuit and/or coding, and the mobile device 2 such as a smartphone or a tablet includes logic, circuit and/or coding. The cross-layer method for sleep scheduling of the present disclosure executed by the base station 1 includes the following steps: S101: searching for a plurality of environment parameters of the base station 1 and at least one mobile device 2; S103: dynamically allocating at least one subframe 3 to a first scheduling block 4 of the at least one mobile device 2 for achieving an initial schedule according to the plurality of environment parameters; and S105: dynamically adjusting the first scheduling block 4 of the at least one mobile device 2 in the at least one subframe 3 and at least one modulation and coding scheme (MCS) corresponding to the first scheduling block 4 for achieving a real-time schedule according to the plurality of environment parameters and the initial schedule.

In S101, the base station 1 searchers for a plurality of environment parameters of the base station 1 and at least one mobile device 2, including an average data rate, a delay rate, a tolerable data loss-rate, a wireless resource, a flexible space resource, an average channel speed, a channel speed, a maximum transmission power, and transmissible data quantity. The at least one modulation and coding scheme can be seen in table 1, wherein the CQI stands for channel quality indicator, the modulation stands for modulation scheme, the code rate stands for velocity, and the efficiency (bits/symbol) indicates how many bits a symbol can include.

TABLE 1

| CQI | modulation | Code rate × 1024 | efficiency |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

The base station 1 chooses a channel bandwidth. As shown in table 2, the transmission bandwidth configuration N is scheduling block (SB), wherein one scheduling block includes two resource blocks.

TABLE 2

| | | | | | | |
|---|---|---|---|---|---|---|
| Channel | 1.4 | 3 | 5 | 10 | 15 | 20 |
| bandwidth | | | | | | |
| BW(MHz) | | | | | | |
| Transmission | 5 | 15 | 25 | 50 | 75 | 100 |
| bandwidth | | | | | | |
| configuration | | | | | | |
| N | | | | | | |

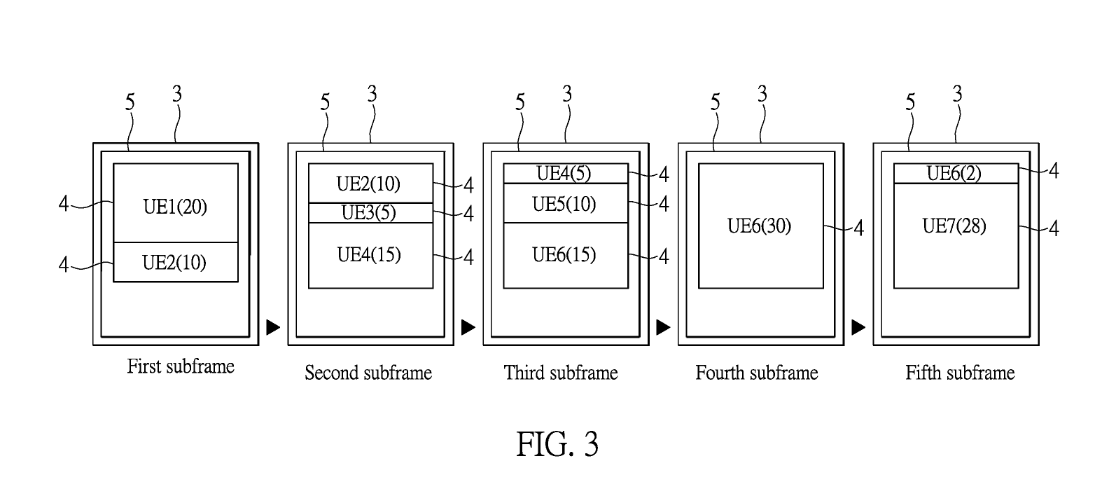

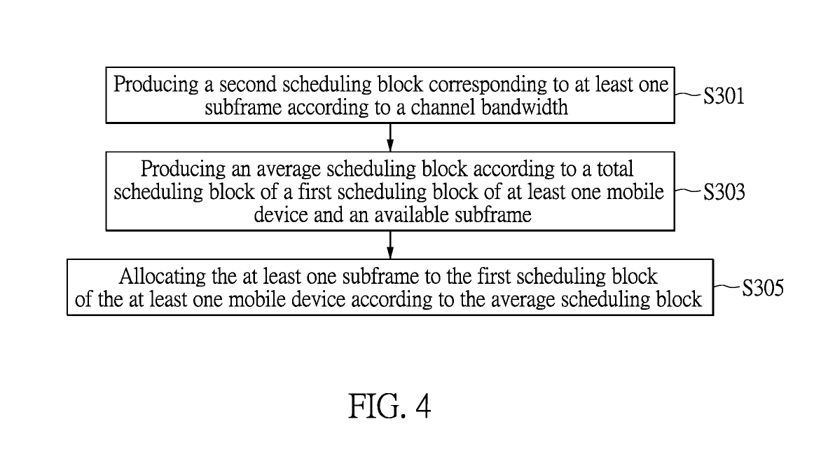

In S103, the base station 1 dynamically allocates the at least one subframe 3 to the first scheduling block 4 of the at least one mobile device 2 for achieving an initial schedule according to the plurality of environment parameters. As shown in FIG. 3, the base station 1 serves to seven mobile devices which are respectively denoted as a first mobile device UE1, a second mobile device UE2, a third mobile device UE3, a fourth mobile device UE4, a fifth mobile device UE5, a sixth mobile device UE6 and a seventh mobile device UE7, wherein the first mobile device UE1 has to use 20 scheduling blocks, the second mobile device UE2 has to use 20 scheduling blocks, the third mobile device UE3 has to use 5 scheduling blocks, the fourth mobile device UE4 has to use 20 scheduling blocks, the fifth mobile device UE5 has to use 10 scheduling blocks, the sixth mobile device UE6 has to use 47 scheduling blocks, and the seventh mobile device UE7 has to use 28 scheduling blocks. Please refer to FIG. 4. The base station 1 dynamically allocating the at least one subframe 3 to the first scheduling block 4 of the at least one mobile device 2 for achieving an initial schedule according to the plurality of environment parameters includes the steps: S301: producing a second scheduling block 5 corresponding to the at least one subframe 3 according to a channel bandwidth; S303: producing an average scheduling block according to a total scheduling block of the first scheduling block 4 of the at least one mobile device 2 and an available subframe; and S305: allocating the at least one subframe 3 to the first scheduling block 4 of the at least one mobile device 2 according to the average scheduling block. In S301, the base station 1 chooses a channel bandwidth, and produces a scheduling block corresponding to the at least one subframe 3 according to the channel bandwidth. In an exemplary embodiment, the channel bandwidth the base station 1 chooses is 10 MHz, and the at least one subframe 3 corresponding to the 10 MHz channel bandwidth includes 50 scheduling blocks. In S303, the base station 1 obtains the available subframe applicable to the cross-layer method for sleep scheduling according to the plurality of environment parameters, and calculates a total of scheduling blocks used by the seven mobile devices UE1-UE7 to be 150 (20+20+5+20+10+47+28=150). In the exemplary embodiment, the base station 1 obtains 5 available subframes according to the plurality of environment parameters, which are respectively a first subframe, a second subframe, a third subframe, a fourth subframe, and a fifth subframe. In addition, the base station 1 calculates the average scheduling block to be 30 according to a total of 150 scheduling blocks and 5 available subframes (150/5=30). In S305, the base station 1 allocates 30 scheduling blocks of each subframe 3 to the mobile devices UE1-UE7 according to the average scheduling block to execute scheduling. Here, the mobile devices UE2, UE4 and UE6 are cross the subframe 3, causing a long duration and more power consumption. Thus the present disclosure provides another initial schedule to lower power consumption rate.

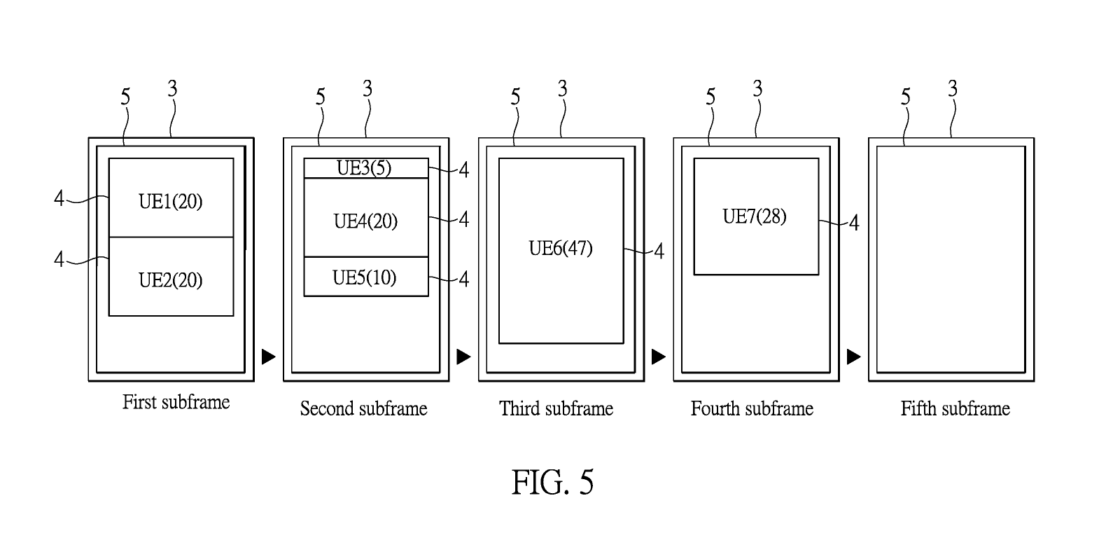

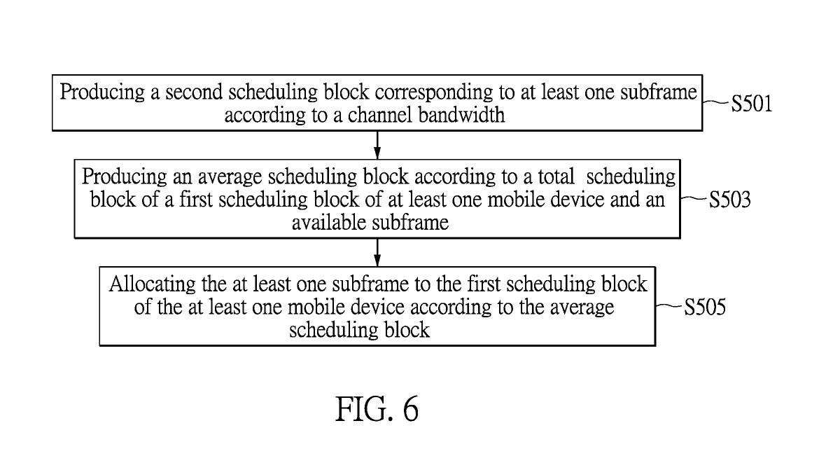

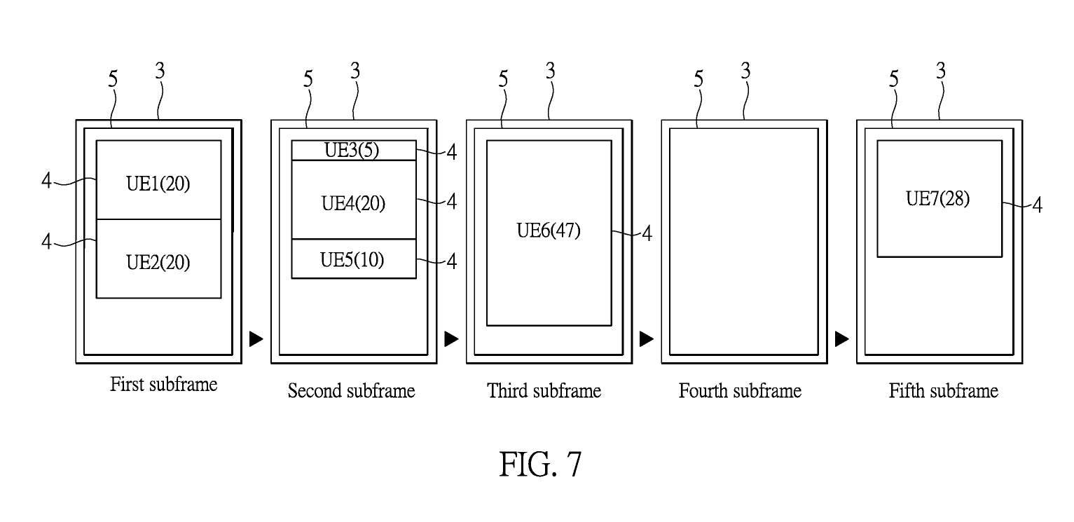

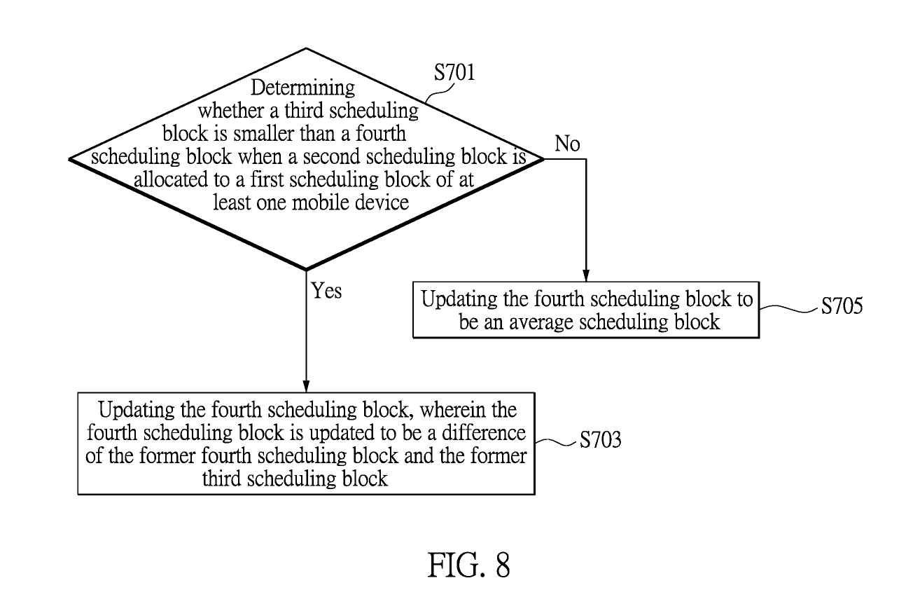

As shown in FIG. 5 and FIG. 6, the base station 1 dynamically allocating the at least one subframe 3 to the first scheduling block 4 of the at least one mobile device 2 for achieving an initial schedule according to the plurality of environment parameters includes the steps: S501: producing a second scheduling block 5 corresponding to the at least one subframe 3 according to a channel bandwidth; S503: producing an average scheduling block according to a total scheduling block of the first scheduling block 4 of the at least one mobile device 2 and an available subframe; and S505: allocating the at least one subframe 3 to the first scheduling block 4 of the at least one mobile device 2 according to the average scheduling block. For S501 and S503 are respectively the same as S301 and S303, unnecessary details are not repeated. In S505, in order to prevent the mobile device 2 from crossing the subframe 3 to cause a long duration to increase the power consumption, the base station 1 allocates each subframe 3 to the scheduling block of the at least one mobile device 2, and each subframe 3 includes a complete scheduling block of the at least one mobile device 2. As shown in FIG. 8, the base station 1 allocating each subframe 3 to the scheduling block of the at least mobile device 2 includes the steps: S701: determining whether a third scheduling block is smaller than a fourth scheduling block when the second scheduling block 5 is allocated to the first scheduling block 4 of the at least one mobile device 2; S703: if the third scheduling block has been determined to be smaller than the fourth scheduling block, updating the fourth scheduling block, wherein the fourth scheduling block is updated to be a difference of the former fourth scheduling block and the former third scheduling block; and S705: if the third scheduling block has been determined not to be smaller than the fourth scheduling block, updating the fourth scheduling block to be the average scheduling block, wherein the third scheduling block is equal to a difference of the first scheduling block 4 of the at least one mobile device 2 and the average scheduling block, and an initial schedule of the fourth scheduling block is the average scheduling block. Take the first subframe as an example, the base station 1 allocates the scheduling block of the first subframe to the first mobile device UE1 and the scheduling block of the second mobile device UE2, and determines whether the 40 scheduling blocks (20+20) of the first mobile device UE1 and the second mobile device UE2 are smaller than the average scheduling block which is a total of 30, wherein the third scheduling block indicates a difference of the scheduling block of each of the mobile devices UE1-UE7 and the average scheduling block in each subframe 3. The updated fourth scheduling block indicates a difference of the fourth scheduling block and the third scheduling block in the former subframe 3. In the first subframe, the third scheduling block is 20+20−30=10, the fourth scheduling block is the average scheduling block, and the base station 1 determines that the third scheduling block is smaller than the fourth scheduling block, so the fourth scheduling block is updated to be 30−10=20. In the second subframe, the third scheduling block is 5+20+10−30=5, the fourth scheduling block is 20, and the base station 1 determines that the third scheduling block is smaller than the fourth scheduling block, so the fourth scheduling block is updated to be 20-5=15. In the third subframe, the third scheduling block is 47−30=17, the fourth scheduling block is 15, and the base station 1 determines that the third scheduling block is bigger than the fourth scheduling block, so the base station 1 updates the fourth scheduling block to be the average scheduling block to execute the next initial schedule. As shown in FIG. 7, when the base station 1 determines that the third scheduling block is bigger than the fourth scheduling block, the base station 1 does not allocate the fourth subframe to the seventh mobile device UE7 but allocates the fifth subframe to the seventh mobile device UE7. It is because the scheduling blocks which are respectively allocated to the first to the sixth mobile devices UE1-UE6 in the first, second and third subframes are over the average scheduling block, and the scheduling blocks of the first to the sixth mobile devices UE1-UE6 are all allocated to the first, second and third subframes without allocating to the fourth and fifth subframes, causing the subframe 3 to be used unequally. When one of the six mobile devices UE1-UE6 has a poor transmission channel quality and needs to increase the scheduling block, the base station 1 allocates the fourth subframe to the mobile device which is in a poor transmission channel quality.

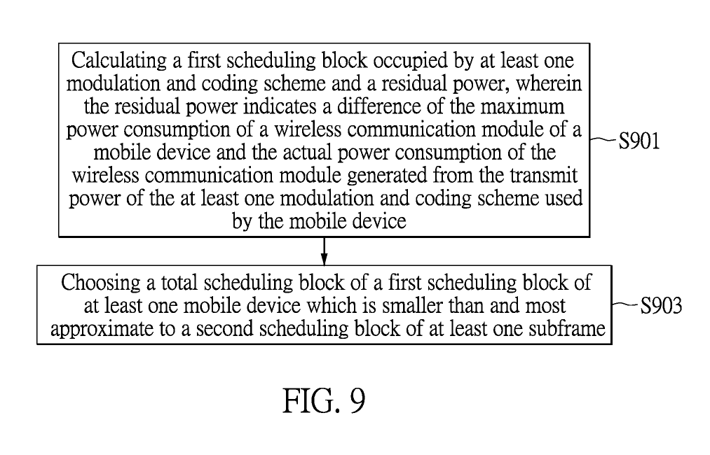

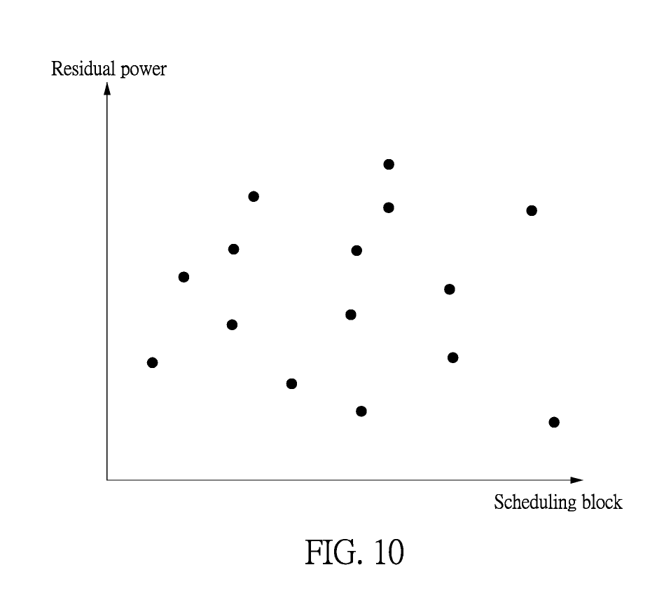

As shown in FIG. 9, in S105, the base station 1 dynamically adjusting the first scheduling block 4 of the at least one mobile device 2 in the at least one subframe 3 and at least one modulation and coding scheme corresponding to the first scheduling block 4 for achieving a real-time schedule according to the plurality of environment parameters and the initial schedule includes the steps: S901: calculating the first scheduling block 4 occupied by the at least one modulation and coding scheme and a residual power, wherein the residual power indicates a difference of the maximum power consumption of a wireless communication module of the mobile device 2 and the actual power consumption of the wireless communication module generated from the transmit power of the at least one modulation and coding scheme used by the mobile device; and S903: choosing a total scheduling block of the first scheduling block 4 of the at least one mobile device 2 which is smaller than and most approximate to the second scheduling block 5 of the at least one subframe 3. In order to increase the scheduling efficiency, the base station 1 calculates the scheduling block occupied by the at least one modulation and coding scheme used by each mobile device 2 and the residual power of each mobile device 2 according to the plurality of environment parameters and the initial schedule. Please refer to FIG. 10, wherein the 15 circular points respectively indicates the distribution of the mobile device 2 using the 15 modulation and coding schemes as shown in table 1, and shows the relationship between the scheduling block (horizontal axis) and the residual power (vertical axis) of the 15 modulation and coding schemes respectively. Here, despite using the same modulation and coding scheme, the scheduling block and residual power of each mobile device 2 are different because of the transmission channel quality between the base station 1 and each mobile device 2. FIG. 10 shows an exemplary embodiment, and the present disclosure is not limited thereto. In an exemplary embodiment, the base station 1 uses a 10 MHz bandwidth, and the corresponding subframe 3 includes 50 scheduling blocks. When the base station 1 allocates the subframe 3 to an eighth mobile device UE8, a ninth mobile device UE9 and a tenth mobile device UE10, the base station 10 calculates the scheduling block and residual power of the eighth mobile device UE8, the ninth mobile device UE9 and the tenth mobile device UE10. Table 3 shows scheduling block and residual power. The base station 1 respectively chooses scheduling blocks of the eighth mobile device UE8, the ninth mobile device UE9 and the tenth mobile device UE10 which are smaller than and most approximate to 50 scheduling blocks of the subframe 3. That is, the base station 1 chooses 15 scheduling blocks of the eighth mobile device UE8, 15 scheduling blocks of the ninth mobile device UE9 and 15 scheduling blocks of the tenth mobile device UE 10 which are a total of 45 scheduling blocks and are smaller than and most approximate to 50 scheduling blocks of the subframe 3 to achieve the real-schedule.

TABLE 3

| | Scheduling block | Residual power |
|---|---|---|
| UE8 | 7 | 27.76 |
| | 9 | 30.46 |
| | 15 | 35.61 |
| | 31 | 38.77 |
| UE9 | 15 | 0.16 |
| | 23 | 0.23 |
| | 30 | 2.11 |
| | 46 | 3.53 |
| UE10 | 7 | 27.76 |
| | 15 | 30.46 |
| | 31 | 35.61 |

In summary, the initial schedule provided by the cross-layer method for sleep scheduling of the present disclosure enables the mobile device 2 to execute an initial schedule when the base station 1 is in sleep mode, and then the mobile device 2 is maintained in sleep mode or is activated according to the initial schedule, so that the mobile device 2 can avoid entering sleep mode frequently. The real-time schedule provided by the cross-layer method for sleep scheduling of the present disclosure dynamically allocates the scheduling block and determines the modulation and coding scheme according to the transmission channel quality between the mobile device 2 and the base station 1. In addition, the cross-layer method for sleep scheduling of the present disclosure provides the mobile device 2 with the delay constraint to save power. That is, when the mobile device 2 is in a poor transmission channel quality, the data transmission of the mobile device 2 is delayed until the transmission channel quality becomes better, without affecting the quality of service of the mobile device 2. For example, the mobile device 2 starts to transmit data when the next subframe 3 comes.

In addition, each subframe 3 includes two types of mobile devices. One of the mobile devices has a good transmission channel quality, and the other is in a poor one. Data transmission of the mobile device 2 having a poor transmission channel quality is delayed several times for lowering an amount of transmitting data Qᵢ of the mobile device 2 and to increase the possibility of transmitting the data that have been delayed. The present disclosure further provides a weight vector Iᵢ to enable the mobile device 2 having a poor transmission channel quality to be activated in the next subframe 3 to transmit data. The weight vector Iᵢ is indicated as follows, wherein Cᵢ stands for the current channel speed (bits/SB) of the mobile device 2, C_{i(ayg)} stands for an average channel speed of the mobile device 2, Qᵢ stands for an amount of data to be transmitted of the mobile device 2, Rᵢ stands for the transmission rate of data, Δᵢ stands for the delay frequency, Dᵢ stands for the delay margin, and Tᵢ stands for the cycle of the subframe 3.

Iᵢ=Cᵢ×(Cᵢ/C_{i(avg)})×(Qᵢ/Rᵢ)(1+Δᵢ/(Dᵢ/Tᵢ))

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A cross-layer method for sleep scheduling executed by a base station serving to at least one user equipment, wherein the method comprises the steps:
searching for a plurality of environment parameters of the base station and the at least one mobile device;
dynamically allocating at least one subframe to a first scheduling block of the at least one mobile device for achieving an initial schedule according to the plurality of environment parameters; and
dynamically adjusting the first scheduling block of the at least one mobile device in the at least one subframe and at least one modulation and coding scheme corresponding to the first scheduling block for achieving a real-time schedule according to the plurality of environment parameters and the initial schedule.

2. The cross-layer method for sleep scheduling according to claim 1, wherein the plurality of environment parameters comprise an average data rate, a delay rate, a tolerable data loss-rate, a wireless resource, a flexible space resource, an average channel speed, a channel speed, a maximum transmission power, and transmissible data quantity.

3. The cross-layer method for sleep scheduling according to claim 2, wherein the base station dynamically allocating the at least one subframe to the first scheduling block of the at least one mobile device for achieving an initial schedule according to the plurality of environment parameters comprises:
producing a second scheduling block corresponding to the at least one subframe according to a channel bandwidth;
producing an average scheduling block according to a total scheduling block of the first scheduling block of the at least one mobile device and an available subframe; and
allocating the at least one subframe to the first scheduling block of the at least one mobile device according to the average scheduling block.

4. The cross-layer method for sleep scheduling according to claim 2, wherein the base station dynamically allocating the at least one subframe to the first scheduling block of the at least one mobile device for achieving an initial schedule according to the plurality of environment parameters comprises:
producing a second scheduling block corresponding to the at least one subframe according to a channel bandwidth;
producing an average scheduling block according to a total scheduling block of the first scheduling block of the at least one mobile device and an available subframe; and
allocating the at least one subframe to the first scheduling block of the at least one mobile device according to the average scheduling block.

5. The cross-layer method for sleep scheduling according to claim 4, wherein the base station dynamically allocating the at least one subframe to the first scheduling block of the at least one mobile device for achieving an initial schedule according to the plurality of environment parameters comprises:
determining whether a third scheduling block is smaller than a fourth scheduling block when the second scheduling block is allocated to the first scheduling block of the at least one mobile device; and
updating the fourth scheduling block;
wherein the third scheduling block is equal to a difference of the first scheduling block of the at least one mobile device and the average scheduling block;
wherein an initial scheduling block of the fourth scheduling block is the average scheduling block, and the fourth scheduling block is updated to be a difference of the former fourth scheduling block and the former third scheduling block.

6. The cross-layer method for sleep scheduling according to claim 5, wherein the base station dynamically allocating the at least one subframe to the first scheduling block of the at least one mobile device for achieving an initial schedule according to the plurality of environment parameters comprises:
determining whether the third scheduling block is bigger than the fourth scheduling block when the second scheduling block is allocated to the first scheduling block of the at least one mobile device; and
updating the fourth scheduling block to be the average scheduling block.

7. The cross-layer method for sleep scheduling according to claim 6, wherein when the third scheduling block has been determined to be bigger than the fourth scheduling block, the at least one subframe is not allocated.

8. The cross-layer method for sleep scheduling according to claim 2, wherein the base station dynamically adjusting the first scheduling block of the at least one mobile device in the at least one subframe and at least one modulation and coding scheme corresponding to the first scheduling block for achieving a real-time schedule according to the plurality of environment parameters and the initial schedule comprises:
calculating the first scheduling block occupied by the at least one modulation and coding scheme and a residual power, wherein the residual power indicates a difference of the maximum power consumption of a wireless communication module of the mobile device and the actual power consumption of the wireless communication module generated from the transmit power of the at least one modulation and coding scheme used by the mobile device; and
choosing a total scheduling block of the first scheduling block of the at least one mobile device which is smaller than and most approximate to the second scheduling block of the at least one subframe.

9. A base station adapted to serve to at least one mobile device and execute a cross-layer method for sleep scheduling, comprises the steps:
searching for a plurality of environment parameters of the base station and the at least one mobile device;
dynamically allocating at least one subframe to a first scheduling block of the at least one mobile device for achieving an initial schedule according to the plurality of environment parameters; and
dynamically adjusting the first scheduling block of the at least one mobile device in the at least one subframe and at least one modulation and coding scheme corresponding to the first scheduling block for achieving a real-time schedule according to the plurality of environment parameters and the initial schedule.

10. The base station adapted to serve to at least one mobile device and a cross-layer method for sleep scheduling according to claim 9, wherein the plurality of environment parameters comprise an average data rate, a delay rate, a tolerable data loss-rate, a wireless resource, a flexible space resource, an average channel speed, a channel speed, a maximum transmission power, and transmissible data quantity.

11. The base station adapted to serve to at least one mobile device and a cross-layer method for sleep scheduling according to claim 10, wherein the base station dynamically allocating the at least one subframe to the first scheduling block of the at least one mobile device for achieving an initial schedule according to the plurality of environment parameters comprises:
producing a second scheduling block corresponding to the at least one subframe according to a channel bandwidth;
producing an average scheduling block according to a total scheduling block of the first scheduling block of the at least one mobile device and an available subframe; and
allocating the at least one subframe to the first scheduling block of the at least one mobile device according to the average scheduling block.

12. The base station adapted to serve to at least one mobile device and a cross-layer method for sleep scheduling according to claim 10, wherein the base station dynamically allocating the at least one subframe to the first scheduling block of the at least one mobile device for achieving an initial schedule according to the plurality of environment parameters comprises:
producing a second scheduling block corresponding to the at least one subframe according to a channel bandwidth;
producing an average scheduling block according to a total scheduling block of the first scheduling block of the at least one mobile device and an available subframe; and
allocating the at least one subframe to the first scheduling block of the at least one mobile device according to the average scheduling block.

13. The base station adapted to serve to at least one mobile device and a cross-layer method for sleep scheduling according to claim 12, wherein the base station dynamically allocating the at least one subframe to the first scheduling block of the at least one mobile device for achieving an initial schedule according to the plurality of environment parameters comprises:
determining whether a third scheduling block is smaller than a fourth scheduling block when the second scheduling block is allocated to the first scheduling block of the at least one mobile device; and
updating the fourth scheduling block;
wherein the third scheduling block is equal to a difference of the first scheduling block of the at least one mobile device and the average scheduling block, and an initial scheduling block of the fourth scheduling block is the average scheduling block, and the fourth scheduling block is updated to be a difference of the former fourth scheduling block and the former third scheduling block.

14. The base station adapted to serve to at least one mobile device and a cross-layer method for sleep scheduling according to claim 13, wherein the base station dynamically allocating the at least one subframe to the first scheduling block of the at least one mobile device for achieving an initial schedule according to the plurality of environment parameters comprises:
determining whether the third scheduling block is bigger than the fourth scheduling block when the second scheduling block is allocated to the first scheduling block of the at least one mobile device; and
updating the fourth scheduling block to be the average scheduling block.

15. The base station adapted to serve to at least one mobile device and a cross-layer method for sleep scheduling according to claim 14, wherein when the third scheduling block has been determined to be bigger than the fourth scheduling block, the at least one subframe is not allocated.

16. The base station adapted to serve to at least one mobile device and a cross-layer method for sleep scheduling according to claim 10, wherein the base station dynamically adjusting the first scheduling block of the at least one mobile device in the at least one subframe and at least one modulation and coding scheme corresponding to the first scheduling block for achieving a real-time schedule according to the plurality of environment parameters and the initial schedule comprises:
calculating the first scheduling block occupied by the at least one modulation and coding scheme and a residual power, wherein the residual power indicates a difference of the maximum power consumption of a wireless communication module of the mobile device and the actual power consumption of the wireless communication module generated from the transmit power of the at least one modulation and coding scheme used by the mobile device; and
choosing a total scheduling block of the first scheduling block of the at least one mobile device which is smaller than and most approximate to the second scheduling block of the at least one subframe.
